(19) United States
(12) Patent Application Publication
(10) Pub. No.: US 2021/0046993 A1
(43) Pub. Date: Feb. 18, 2021

(54) PEDAL-POWERED WHEELCHAIR

(71) Applicant: Jeff LEWIS, Victoria (CA)

(72) Inventor: Jeff LEWIS, Victoria (CA)

(21) Appl. No.: 16/987,491

(22) Filed: Aug. 7, 2020

Related U.S. Application Data
(60) Provisional application No. 62/885,587, filed on Aug. 12, 2019.

(51) Int. Cl. B62K 5/08; B62M 1/36; B62K 21/00; B62M 11/02; B62J 1/00; B62K 19/18; B62L 3/02

(52) U.S. Cl. CPC B62K 5/08; B62M 1/36; B62K 21/00; B62L 3/023; B62J 1/00; B62K 19/18; B62M 11/02

(57) ABSTRACT

A pedal-powered wheelchair having a steering dolly pivotally mounted at a rear of the wheelchair. When the upper end of a first steering lever is pulled and the upper end of a second steering lever is pushed, a first steering linkage connected to the first steering lever pulls forward a first side of the steering dolly and a second steering linkage connected to the second steering lever pushes rearward a second side of the steering dolly. This causes the steering dolly to turn clockwise to initiate a left turn. When the upper end of the first steering lever is pushed and the upper end of the second steering lever is pulled, the first steering linkage pushes rearward the first side of the steering dolly and the second steering linkage pulls forward the second side of the steering dolly. This causes the steering dolly to turn counterclockwise to initiate a right turn.

### FIELD

There is described a wheelchair which the occupant causes forward or backward movement of the wheelchair by pedalling.

### BACKGROUND

There exist in the patent literature various embodiments of pedal-powered wheelchairs. For example, U.S. Pat. No. 8,517,407 (Handa et al) titled “Three-wheel pedal-style wheelchair”, Japanese patent publication 2011160914 (Yoshikata) titled “Pedal-powered Wheelchair”, Japanese patent publication 2013233281 (Junichi) titled “Pedal-driven Wheelchair”, and Japanese patent publication 2014104191 (Junichi) titled “Pedal-driven wheelchair”.

Although not described as a “wheelchair” there are a series of related patents U.S. Pat. Nos. 9,757,288; 9,757,289; and U.S. Pat. No. 10,076,476 (Simons et al) all titled “Mobile Chair Apparatus Comprising Foot Pedals”.

### SUMMARY

There is provided a pedal-powered wheelchair consisting of a frame having a front, a rear, a first side and a second side, with a seat supported by the frame and a horizontal member extending horizontally from the front of the frame. The horizontal member has a remote end at a distance from the front of the frame. A non-steerable first driven wheel is positioned on the first side of the frame and a non-steerable second driven wheel is positioned on the second side of the frame. A pedal crank is rotatably mounted at the remote end of the horizontal member. A drive linkage is provided that converts human powered rotary input of the pedal crank into rotation of at least one and preferably both of the first driven wheel and the second driven wheel. A two wheeled steering dolly is pivotally mounted at the rear of the frame. The steering dolly has a first side with a first wheel and a second side with a second wheel. The steering dolly pivots about a substantially vertical steering axis centrally positioned between the first side and the second side of the steering dolly. A first steering lever is provided having an upper end and a lower end. The first steering lever is pivotally mounted at the front of the frame on the first side for movement about a first pivot positioned in an intermediate position between the upper end and the lower end of the first steering lever. A second steering lever is provided having an upper end and a lower end. The second steering lever is pivotally mounted at the front of the frame on the second side for movement about a second pivot positioned in an intermediate position between the upper end and the lower end of the second steering lever. A first steering linkage extends from the lower end of the first steering lever to the first side of the steering dolly. A second steering linkage extends from the lower end of the second steering lever to the second side of the steering dolly. When human powered input pulls on the upper end of the first steering lever and concurrently pushes on the upper end of the second steering lever, the first steering lever pivots about the first pivot thereby moving the lower end of the first steering lever forward with the first steering linkage pulling forward the first side of the steering dolly and the second steering lever pivots about the second pivot thereby moving the lower end of the second steering lever rearward with the second steering linkage pushing rearward the second side of the steering dolly. This causes the steering dolly to turn clockwise about the steering axis to initiate a left turn. When the human powered input pushes on the upper end of the first steering lever and concurrently pulls on the upper end of the second steering lever, the first steering lever pivots about the first pivot thereby moving the lower end of the first steering lever rearward with the first steering linkage pushing rearward the first side of the steering dolly and the second steering lever pivots about the second pivot thereby moving the lower end of the second steering lever forward with the second steering linkage pulling forward the second side of the steering dolly. This causes the steering dolly to turn counterclockwise about the steering axis to initiate a right turn.

Although beneficial results may be obtained from the pedal-powered wheelchair described above, the drive linkage used with bicycles is not ideally suited for a wheelchair application. The reason for this, is that a bicycle cannot be backed up by pedalling backwards. However, in a wheelchair application, it is advantageous to be able to back up. Even more beneficial results may, therefore, be obtained when rotating input of the pedal crank in a first rotary direction causes rotation of at least one of the first driven wheel or the second driven wheel in a first direction and rotating input of the pedal crank in a second rotary direction causes rotation of at least one of the first driven wheel or the second driven wheel in a second direction.

Although beneficial results may be obtained through the use of the pedal-powered wheelchair, as described above, cornering at speed functions much better if the drive linkage includes a differential which allows differential rotation of the first driven wheel and the second driven wheel when turning.

Although beneficial results may be obtained through the use of the pedal-powered wheelchair, as described above, occupants of the wheelchair may differ in height. Even occupants who are the same height may differ in the length of their legs. Even more beneficial results may, therefore, be obtained when the seat is movable on the frame, with a plurality of seat fixing positions to selectively adjust the distance between the seat and the pedal crank.

Although beneficial results may be obtained through the use of the pedal-powered wheelchair, as described above, it is desirable to avoid jarring impacts when the wheelchair navigates over curbs or other obstacles. Even more beneficial results may be obtained when the steering dolly is also connected to the frame by a horizontal linkage, with a shock absorber is positioned between the frame and the steering dolly to absorb movement about the horizontal linkage.

Although beneficial results may be obtained through the use of the pedal-powered wheelchair, as described above, in order to maintain control over the pedal-powered wheelchair the user must be able to stop as needed. Even more beneficial results may, therefore, be obtained when a brake actuator is located on at least one of the first steering lever or the second steering lever. The brake actuator is hydraulically connected to brakes on the first wheel and the second wheel of the steering dolly.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of the pedal-powered wheelchair, going straight forward.

FIG. 2 is a side elevation view of the pedal-powered wheelchair of FIG. 1, turning right.

FIG. 3 is a side elevation view of the pedal-powered wheelchair of FIG. 1, turning left.

FIG. 4 is a front elevation view of the pedal-powered wheelchair of FIG. 1.

### DETAILED DESCRIPTION

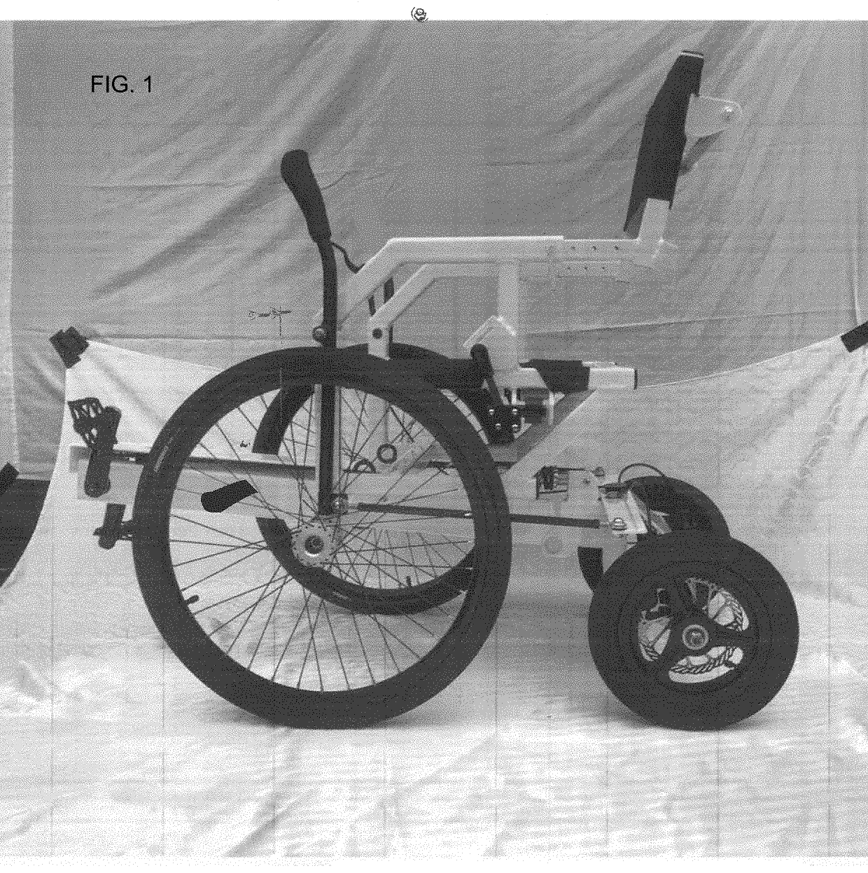

A pedal-powered wheelchair generally identified by reference numeral 10, will now be described with reference to FIG. 1 through FIG. 4.

Structure and Relationship of Parts:

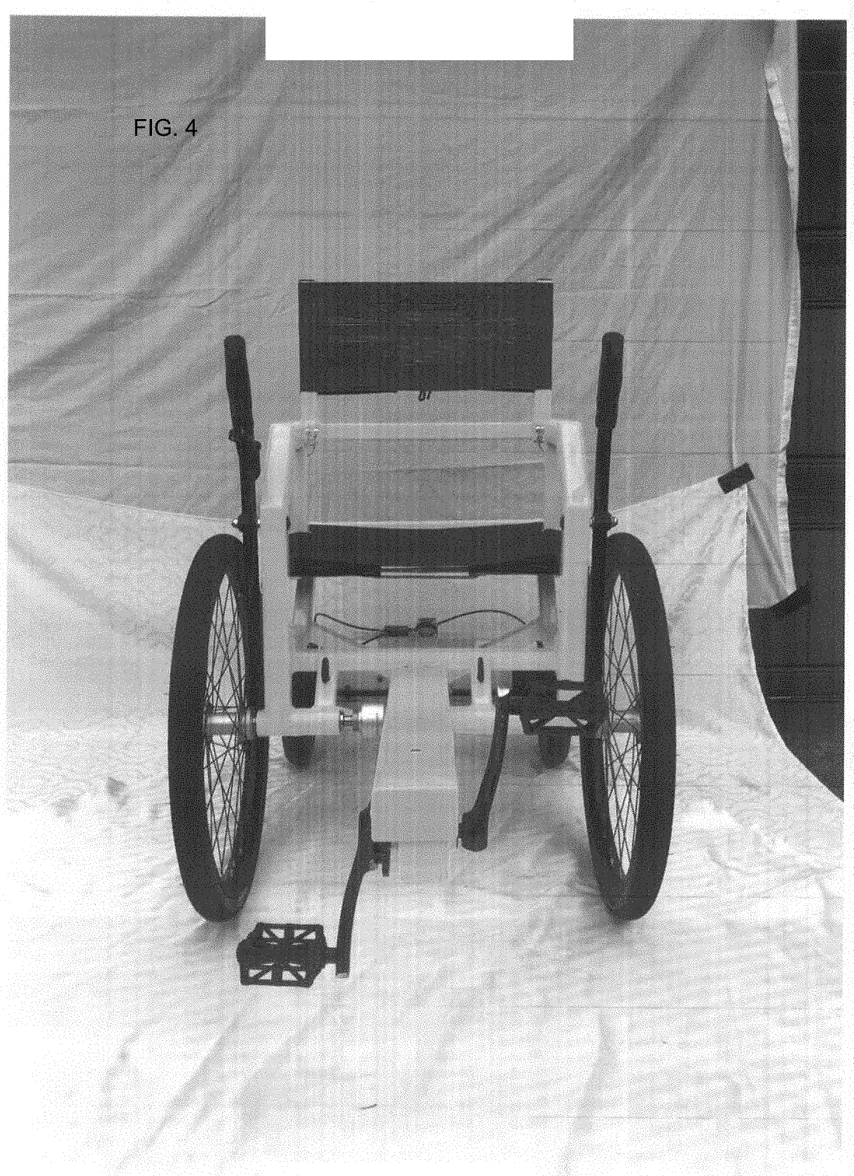

Referring to FIG. 1, pedal-powered wheelchair 10 includes a frame 12 having a front 14 and a rear 16. Referring to FIG. 4, frame 12 has a first side 18 and a second side 20. Referring to FIG. 1 and FIG. 4, a seat 22 is supported by frame 12 and a horizontal member 24 extends horizontally from front 14 of frame 12. Horizontal member 24 has a remote end 26 at a distance from front 14 of frame 12. A non-steerable first driven wheel 28 is positioned on first side 18 of frame 12 and a non-steerable second driven wheel 30 is positioned on second side 20 of frame 12. A pedal crank 32 is rotatably mounted at remote end 26 of horizontal member 24.

A drive linkage, generally indicated by reference numeral 34 is provided that converts human powered rotary input of pedal crank 32 into rotation at least one and preferably both of first driven wheel 28 and second driven wheel 30. The reason that it is preferred to drive both first driven wheel 28 and second driven wheel 30, is that with a single wheel slippage may occur. Rotating input into pedal crank 32 in a first rotary direction (forward) causes rotation of first driven wheel 28 and second driven wheel 30 in a first direction (forward). Rotating input into pedal crank 32 in a second rotary direction (backward) causes rotation of first driven wheel 28 and second driven wheel 30 in a second direction (backward). Drive linkage 34 includes a differential 36 which allows differential rotation of first driven wheel 28 and second driven wheel 30 when turning.

Referring to FIG. 1, seat 22 has a back support 38 which is movable on frame 12. Back support 38 is attached to a first tubular member 40 which is telescopically connected to a second tubular member 42. There are a plurality of back support fixing positions defined by a plurality of apertures 44 in first tubular member 40. Second tubular member 42 has a single aperture 46. First tubular member 40 and second tubular member 42 are locked in a selected telescopic position by inserting a locking pin 48 through aperture 46 of tubular member 42 and through a selected one of apertures 44 in first tubular member 40. This fixes the distance between back support 38 and pedal crank 32.

Referring to FIG. 1, a two wheeled steering dolly 50 is pivotally mounted at rear 16 of frame 12. Steering dolly 50 has a first side 52 with a first wheel 54 and a second side 56 with a second wheel 58. Steering dolly 50 pivots about a substantially vertical steering axis 60 defined by pivot pin 62. Vertical steering axis 60 is centrally positioned between first side 52 and second side 56 of steering dolly 50.

Referring to FIG. 1 and FIG. 4, a first steering lever 64 is provided having an upper end 66 and a lower end 68. First steering lever 64 is pivotally mounted at front 14 of frame 12 on first side 18 for movement about a first pivot 70 positioned in an intermediate position between upper end 66 and lower end 68 of first steering lever 64. A second steering lever 74 is provided having an upper end 76 and a lower end 78. Second steering lever 74 is pivotally mounted at front 14 of frame 12 on second side 20 for movement about a second pivot 80 positioned in an intermediate position between upper end 76 and lower end 78 of second steering lever 74. A first steering linkage 72 extends from lower end 68 of first steering lever 64 to first side 52 of steering dolly 50. A second steering linkage 82 extends from lower end 78 of second steering lever 74 to second side 56 of steering dolly 50.

Referring to FIG. 1, steering dolly 50 is also connected to frame 12 by a horizontal linkage 84. A shock absorber 86 is positioned between frame 12 and steering dolly 50 to absorb movement about horizontal linkage 84.

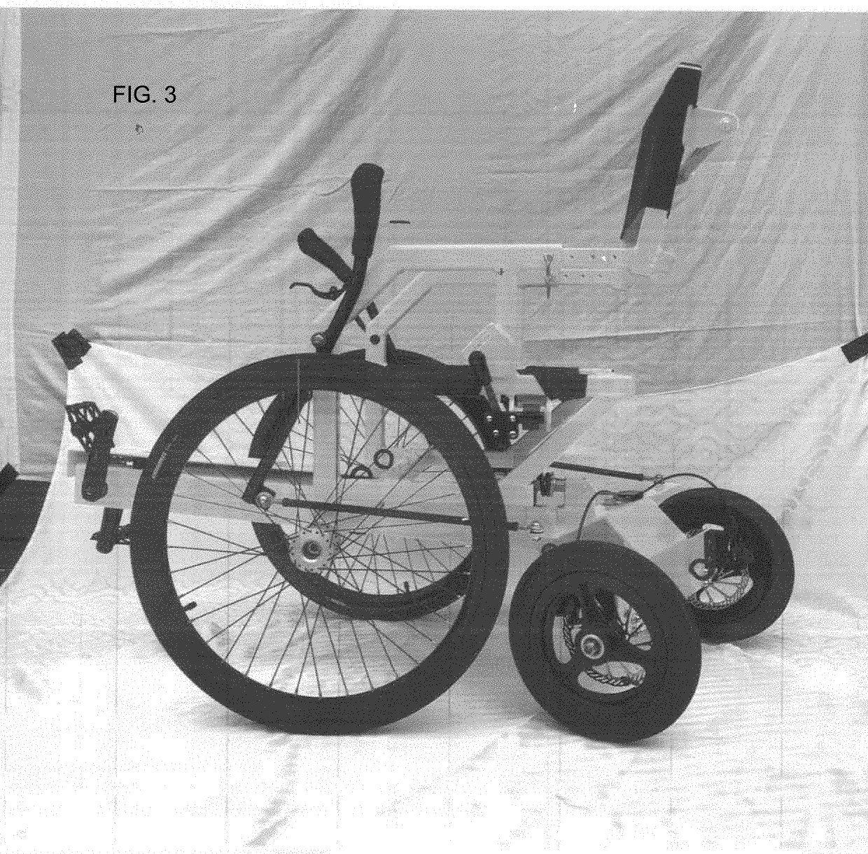

Referring to FIG. 3, a brake actuator 86 is located on one of first steering lever 64 or the second steering lever 74, brake actuator 86 is connected by hydraulic lines 88 to hydraulic brakes 90 on first wheel 54 and second wheel 58 of steering dolly 50.

Operation:

Referring to FIG. 3, when human powered input pulls on upper end 66 of first steering lever 64 and concurrently pushes on upper end 76 of second steering lever 74, it causes steering dolly 50 to turn clockwise about steering axis 60 to initiate a left turn. This is because, when upper end 66 of first steering lever 64 is pushed, first steering lever 64 pivots about first pivot 70 thereby moving lower end 68 of first steering lever 64 forward with first steering linkage 72 pulling forward first side 52 of steering dolly 50. Concurrently pushing on upper end 76 of second steering lever 74, causes second steering lever 74 to pivot about second pivot 80, thereby moving lower end 78 of second steering lever 74 rearward with second steering linkage 82 pushing rearward second side 56 of steering dolly 50.

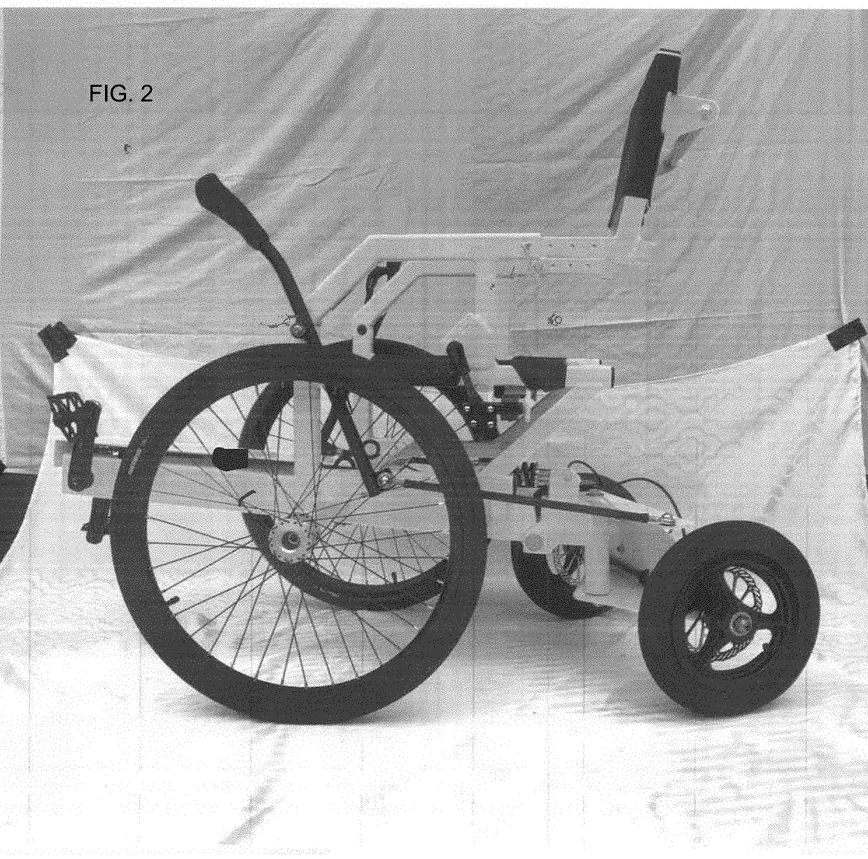

Referring to FIG. 2, when the human powered input pushes on upper end 66 of first steering lever 64 and concurrently pulls on upper end 76 of second steering lever 74, it causes steering dolly 50 to turn counterclockwise about steering axis 60 to initiate a right turn. This is because, when upper end of first steering lever 64 is pushed, first steering lever 64 pivots about first pivot 70 thereby moving lower end 68 of first steering lever 64 rearward with first steering linkage 72 pushing rearward first side 52 of steering dolly 50. Concurrently pulling on upper end 76 of second steering lever 74, causes second steering lever 74 to pivot about second pivot 80 thereby moving lower end 78 of second steering lever 74 forward with second steering linkage 82 pulling forward second side 56 of steering dolly 50.

### Variations and Advantages

It is believed that the pedal-powered wheelchair, as described above, provides improved manoeuvrability when compared to other pedal-powered wheelchairs that have been proposed and described in the prior art.

Electric motor assisted bicycles are becoming popular, to assist the cyclist in climbing steep hills or for use when the cyclist has become fatigued. A possible variation is to equip the pedal-powered wheelchair, described above, with an electric motor assist for the same reasons.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A pedal-powered wheelchair, comprising:
a frame having a front, a rear, a first side and a second side;
a seat supported by the frame;
a horizontal member extending horizontally from the front of the frame, the horizontal member having a remote end at a distance from the front of the frame;
a non-steerable first driven wheel on the first side of the frame and a non-steerable second driven wheel on the second side of the frame;
a pedal crank rotatably mounted at the remote end of the horizontal member;
a drive linkage converting human powered rotary input of the pedal crank into rotation of at least one of the first driven wheel or the second driven wheel;
a two wheeled steering dolly pivotally mounted at the rear of the frame, the steering dolly having a first side with a first wheel and a second side with a second wheel, the steering dolly pivoting about a substantially vertical steering axis centrally positioned between the first side and the second side of the steering dolly;
a first steering lever having an upper end and a lower end, the first steering lever being pivotally mounted at the front of the frame on the first side for movement about a first pivot positioned in an intermediate position between the upper end and the lower end of the first steering lever;
a second steering lever having an upper end and a lower end, the second steering lever being pivotally mounted at the front of the frame on the second side for movement about a second pivot positioned in an intermediate position between the upper end and the lower end of the second steering lever;
a first steering linkage extending from the lower end of the first steering lever to the first side of the steering dolly and a second steering linkage extending from the lower end of the second steering lever to the second side of the steering dolly;
such that when human powered input pulls on the upper end of the first steering lever and concurrently pushes on the upper end of the second steering lever, the first steering lever pivots about the first pivot thereby moving the lower end of the first steering lever forward with the first steering linkage pulling forward the first side of the steering dolly and the second steering lever pivots about the second pivot thereby moving the lower end of the second steering lever rearward with the second steering linkage pushing rearward the second side of the steering dolly, thereby causing the steering dolly to turn clockwise about the steering axis to initiate a left turn;
such that when the human powered input pushes on the upper end of the first steering lever and concurrently pulls on the upper end of the second steering lever, the first steering lever pivots about the first pivot thereby moving the lower end of the first steering lever rearward with the first steering linkage pushing rearward the first side of the steering dolly and the second steering lever pivots about the second pivot thereby moving the lower end of the second steering lever forward with the second steering linkage pulling forward the second side of the steering dolly, thereby causing the steering dolly to turn counterclockwise about the steering axis to initiate a right turn.

2. The pedal-powered wheelchair of claim 1, where rotating input of the pedal crank in a first rotary direction causes rotation of at least one of the first driven wheel or the second driven wheel in a first direction and rotating input of the pedal crank in a second rotary direction causes rotation of at least one of the first driven wheel or the second driven wheel in a second direction.

3. The pedal-powered wheelchair of claim 1, wherein the drive linkage includes a differential which allows differential rotation of the first driven wheel and the second driven wheel when turning.

4. The pedal-powered wheelchair of claim 1, wherein the seat is movable on the frame, with a plurality of seat fixing positions to selectively adjust the distance between the seat and the pedal crank.

5. The pedal-powered wheelchair of claim 1, wherein the steering dolly is also connected to the frame by a horizontal linkage, with a shock absorber is positioned between the frame and the steering dolly to absorb movement about the horizontal linkage.

6. The pedal-powered wheelchair of claim 1, wherein a brake actuator is located on at least one of the first steering lever or the second steering lever, the brake actuator being hydraulically connected to brakes on the first wheel and the second wheel of the steering dolly.
